(19) United States
(12) Patent Application Publication
(10) Pub. No.: US 2022/0340705 A1
(43) Pub. Date: Oct. 27, 2022

(54) POLYOL RESIN BLEND FOR USE IN PRODUCING STABLE POLYOL COMPONENTS

(71) Applicant: Huntsman Petrochemical LLC, The Woodlands, TX (US)

(72) Inventors: DiAnne Pham, The Woodlands, TX (US); Matthew T. Meredith, The Woodlands, TX (US); Robert A. Grigsby, The Woodlands, TX (US)

(21) Appl. No.: 17/764,352

(22) PCT Filed: Sep. 16, 2020
(86) PCT No.: PCT/US2020/050996

§ 371 Date: Mar. 28, 2022

Related U.S. Application Data
(60) Provisional application No. 62/909,308, filed on Oct. 2, 2019.

(51) Int. Cl. C08G 18/20; C08J 9/14; C08G 18/18

(52) U.S. Cl. CPC C08G 18/2027; C08J 9/146; C08G 18/1833; C08G 18/1825; C08G 18/1808; C08J 2375/04; C08J 2203/162; C08J 2205/10; C08J 2205/06; C08G 2110/0008; C08G 2110/0025

(57) ABSTRACT

The present disclosure relates to a polyol resin blend for use in a polyurethane formulation. The polyol resin blend generally includes (a) an amine having a pKa value between about 6 and about 8.5 and a protonated amine obtained by contacting a methylamino-containing tertiary amine or primary etheramine having a pKa value greater than about 9 and an acid compound, (b) a polyol, and (c) a halogenated olefin. The present disclosure also provides polyurethane formulations containing the polyol resin blend and methods of making polyurethane foam from such polyurethane formulations.

### CROSS-REFERENCE TO RELATED APPLICATION

Not applicable.

### STATEMENT REGARDING FEDERALLY SPONSORED RESEARCH OR DEVELOPMENT

Not applicable.

### FIELD

The present disclosure generally relates to a polyol resin blend comprising a polyol and an amine catalyst blend, a polyurethane foam formulation comprising the polyol resin blend and an isocyanate component comprising a compound containing an isocyanate functional group, methods for stabilizing the polyol resin blend by adding the amine catalyst blend to a polyol and methods of making polyurethane foam.

### BACKGROUND

Polyurethane foams are widely known and used in a variety of applications, such as in the automotive and housing industry. These foams are produced by the reaction of a polyisocyanate with a polyol in the presence of various additives. One such additive is an amine catalyst which is used to accelerate gelling (the reaction of a polyol with polyisocyanate) and blowing (reaction of water with polyisocyanate to produce CO₂). Without a proper balance of the gelling and blowing reaction, the physical properties of the foams (during and after formation) will be undesirable, having poor cell structure, higher thermal conductivity, and/or low physical strength. Typically, a balanced mixture of amine catalysts are used, some of which preferentially accelerate the gelling reaction and some of which preferentially accelerate the blowing reaction. This allows the polymerization reaction to occur while the cell structure is being formed and creates a foam with desirable physical properties.

Many of the conventional amine catalysts that are used on both the gelling and blowing side of the foaming reaction have been found to be unstable with certain non-aqueous blowing agents and in particular with the newer, low global-warming-potential (GWP) halogenated olefin blowing agents, such as trans-1-chloro-3,3,3-trifluoropropene (known as 1233zd(E)) or cis-1,1,1,3,3,3-hexafluoro-2-butene (known as 1366mzz(Z)) because they contain activated double bonds which are highly reactive with the amines. Once a blowing agent molecule reacts with an amine catalyst molecule, the catalytic and foaming properties of such are inhibited, thereby lowering the speed of foam formation and negatively effecting foam quality.

Various attempts have been made to improve the shelf life of polyol blends containing amines and halogenated olefin blowing agents without affecting their ability to catalyze polyurethane foam formulation at a reasonable rate. Most of these attempts have centered around using amines that are deactivated in one way or another (for e.g. sterically hindered or bonded with electron withdrawing groups, i.e. “electronically de-activated”) or by including additives to prevent their reaction with the halogenated olefin blowing agent (see, for e.g., U.S. Ser. No. 10/023,681, US20150266994, US20160130416, U.S. Pat. Nos. 9,550,854, 9,556,303, U.S. Ser. No. 10/308,783B2, U.S. Pat. No. 9,868,837 and US20190177465).

Sterically hindered amines typically contain bulky substituents that are covalently bonded to the nitrogen(s) of one or more amines, which take up more space and lower the nucleophilicity of the amines. An example of a sterically hindered amine would be dicyclohexyl-methylamine, which has two cyclohexyl groups directly attached to the nitrogen atom of a methylamine.

Electronically de-activated amines are typically either aromatic in nature or contain an electron withdrawing group that pulls some electron density away from the nitrogen atoms in the molecule. These amines typically have lower basicities than non-de-activated amines, resulting in lower pKa values (pKa of an amine in this case refers to the acidity of the conjugate acid). Electronically deactivated amines tend to typically be gelling catalysts. Non-limiting examples include imidazoles, morpholines, piperazines, and pyridines.

An example of an additive that might be added to reduce or prevent reaction with the halogenated olefinic blowing agent would be an acidic compound that reacts with a strongly basic amine (pKa>9) to protonate it. This protonation lowers the nucleophilicity of the amine under storage conditions in the B-side polyol resin blend. Acid-blocked blowing amines have traditionally been used to increase the flowability in flexible molded foams or pour-in-place rigid foams. An example of an acid-blocked catalyst in this class is JEFFCAT® LED-103. These amines remain fairly unreactive at the beginning of the reaction, but as the heat from the polymerization increases, the amines more easily dissociate from their respective protons and thereby become “unblocked” and can participate in the catalysis of the reaction.

These different types of deactivated amines can be used alone or in combination, and even though these areas have been well-researched, attempts have yet to achieve blends that have both shelf-life stability, catalytic activity, and balanced gelling and blowing that is comparable to blends containing non-halogenated blowing agents.

Thus, there is a continuing need for the development of systems containing amine catalysts and the newer, low global-warming-potential (GWP) halogenated olefin blowing agents which have both an acceptable catalytic activity and an improved shelf life over the current conventional catalyst/halogenated olefin blowing agent blends.

### SUMMARY

The present disclosure provides a polyol resin blend (also referred to herein as a “B-side”) comprising (a) an amine catalyst blend including: (i) one or more amines having a pKa value between about 6 and about 8.5 and (ii) a protonated amine obtained by contacting a methylamino-containing tertiary amine or primary etheramine having a pKa value greater than about 9 and a compound having a formula (OH)ₐ—R—(COOH)_{b} where R is selected from hydrogen, an alkyl, alkenyl, cycloaliphatic, aromatic, and alkylaromatic group, a and b are integers between 0 and 3 with the proviso that a+b≥1, and when a=1 and b=0, R is selected from an aromatic and alkylaromatic group, (b) a polyol and (c) a halogenated olefin compound blowing agent.

According to another embodiment, the present disclosure provides a polyurethane formulation comprising the polyol resin blend above and a compound containing an isocyanate functional group.

In still another embodiment, the present disclosure provides a method for stabilizing a polyol resin blend comprising a polyol and a halogenated olefin blowing agent for an extended period of time by adding the (a) amine catalyst blend above to the polyol resin blend.

In yet another embodiment there is provided a method of forming a polyurethane material comprising contacting a compound containing an isocyanate functional group and optional auxiliary components in the presence of the polyol resin blend.

### BRIEF DESCRIPTION OF THE DRAWINGS

FIG. 1 depicts the change in top-of-cup times after 6 weeks of storage for polyol resin blends comprising polyol, a halogenated olefin blowing agent and an acid-blocked amine catalyst.

### DETAILED DESCRIPTION

The following terms shall have the following meanings:

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical objects of the article. By way of example, “a catalyst” means one catalyst or more than one catalyst. The phrases “in one embodiment”, “according to one embodiment” and the like generally mean the particular feature, structure, or characteristic following the phrase is included in at least one embodiment of the present disclosure, and may be included in more than one embodiment of the present disclosure. Importantly, such phrases do not necessarily refer to the same aspect. If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The term “substantially free” refers to a composition in which a particular compound or moiety is present in an amount that has no material effect on the composition. In some embodiments, “substantially free” may refer to a composition in which the particular compound or moiety is present in the composition in an amount of less than 2% by weight, or less than 1% by weight, or less than 0.5% by weight, or less than 0.1% by weight, or less than 0.05% by weight, or even less than 0.01% by weight based on the total weight of the composition, or that no amount of that particular compound or moiety is present in the respective composition.

Where substituent groups are specified by their conventional chemical formula, written from left to right, they equally encompass the chemically identical substituents that would result from writing the structure from right to left, for example, —CH₂O— is equivalent to —OCH₂—.

The term “alkyl” refers to straight chain or branched chain saturated hydrocarbon groups having from 1 to 50 carbon atoms or from 1 to 40 carbon atoms, or from 1 to 30 carbon atoms, or from 1 to 20 carbon atoms or from 1 to 10 carbon atoms. In some embodiments, alkyl substituents may be lower alkyl groups. The term “lower” refers to alkyl groups having from 1 to 6 carbon atoms. Examples of “lower alkyl groups” include, but are not limited to, methyl, ethyl, n-propyl, i-propyl, butyl, and pentyl groups.

The term “halogenated olefin” refers to an olefin compound or moiety which may include fluorine, chlorine, bromine or iodine.

The term “extended period of time” may be, but is not limited to, at least 1 day or at least 1 week or at least 2 weeks or at least 3 weeks or at least 4 weeks or at least 5 weeks or at least 6 weeks.

The term “optional” or “optionally” means that the subsequently described event or circumstance may or may not occur, and that the description includes instances where said event or circumstance occurs and instances where it does not.

The present disclosure is generally directed to a polyol resin blend and its use in polyurethane formulations which may include a compound containing an isocyanate functional group. The present disclosure is also directed to rigid or flexible polyurethane foam or other polyurethane material made from a formulation comprising the polyol resin blend as described herein and a compound containing an isocyanate functional group. The term “polyurethane” as used herein, is understood to encompass pure polyurethane, polyurethane polyurea and pure polyurea. It has been surprisingly found that the combination of particular amine catalysts have less reactivity with halogenated olefins than traditional amine catalysts. The combination of such amine catalysts was also surprisingly found to have better catalytic performance than other catalysts, including acid-blocked or sterically hindered amine catalysts. The polyol resin blend was also found to have surprisingly enhanced shelf-life stability for an extended period of time as compared to industry standard polyols containing a halogenated olefin compound blowing agent and catalysts.

According to one embodiment, the polyol resin blend includes an amine catalyst blend comprising (i) one or more amines having a pKa value between about 6 and about 8.5 and (ii) a protonated (i.e., “acid-blocked”) amine obtained by contacting a methylamino-containing tertiary amine or primary etheramine having a pKa value greater than about 9 with a compound having a formula (OH)ₐ—R—(COOH)_{b} where R is selected from hydrogen, an alkyl, alkenyl, cycloaliphatic, aromatic, and alkylaromatic group, a and b are integers between 0 and 3 with the proviso that a+b≥1, and when a=1 and b=0, R is an aromatic or alkylaromatic group.

According to one embodiment, the (i) one or more amines having a pKa value between about 6 and about 8.5 may have a pKa value between about 6.3 to about 8.4 or between about 6.5 and 8.3 or between about 6.8 and about 8.2 or between about 6.6 and about 8.1 or between about 6.7 and about 8.

In one embodiment, the one or more amines having a pKa value between about 6 and about 8.5 is selected from an alkylpiperazine, an alkoxylated piperazine, a morpholine compound, an imidazole and a mixture thereof. In one embodiment, the morpholine compound or imidazole may be substituted with a lower alkyl group or alkoxy group. According to one particular embodiment, the one or more amines having a pKa value between about 6 and about 8.5 may include, but are not limited to, imidazole, 1-methylimidazole, 1-hydroxyethylimidazole, 1,2-dimethylimidazole, 2,4-dimethylimidazole, 1-methyl-2-hydroxyethylimidazole, 1,2,4,5-tetramethylimidazole, 4,5-dimethylimidazole, 1-hydroxyethyl-2-methylimidazole, 1,2-dimethylpiperazine (JEFFCAT® DMP amine), morpholine, N-methylmorpholine (JEFFCAT® NMN amine), N-ethylmorpholine (JEFFCAT® NEM amine), N-butylmorpholine, dimorpholinodiethylether (JEFFCAT® DMDEE amine) or a mixture thereof.

In one embodiment, the amine catalyst blend may include at least 10% by weight of the one or more amines having a pKa value between about 6 and about 8.5, based on the total weight of the amine catalyst blend. In still other embodiments, the amine catalyst blend may include at least 20% by weight or at least 30% by weight or at least 40% by weight or at least 50% by weight, or at least 60% by weight, or at least 70% or at least 80% by weight of the one or more amines having a pKa value between about 6 and about 8.5, based on the total weight of the amine catalyst blend.

In still another embodiment, the amine catalyst blend may include less than 90% by weight of the one or more amines having a pKa value between about 6 and about 8.5, based on the total weight of the amine catalyst blend. In still other embodiments, the amine catalyst blend may include less than 75% by weight or less than 65% by weight or less than 55% by weight or less than 45% by weight, or less than 35% by weight, or less than 25% or less than 15% by weight of the one or more amines having a pKa value between about 6 and about 8.5, based on the total weight of the amine catalyst blend.

According to still another embodiment, the amine catalyst blend may include between 10% by weight to 90% by weight of the one or more amines having a pKa value between about 6 and about 8.5, based on the total weight of the amine catalyst blend. In still other embodiments, the amine catalyst blend may include between 15% by weight to 85% by weight or between 20% by weight to 80% by weight, or between 25% by weight to 75% by weight, or between 30% by weight to 70% by weight, or between 35% to 65% by weight, or between 40% by weight to 60% by weight of the one or more amines having a pKa value between about 6 and about 8.5, based on the total weight of the amine catalyst blend.

The amine catalyst blend also includes (ii) a protonated amine obtained by contacting a methylamino-containing tertiary amine or primary etheramine having a pKa value greater than about 9 with a compound having the formula (OH)ₐ—R—(COOH)_{b} where R is hydrogen, an alkyl, alkenyl, cycloaliphatic, aromatic, or alkylaromatic group, a and b are integers between 0 and 3 with the proviso that a+b≥1, and when a=1 and b=0, R is selected from an aromatic group and an alkylaromatic group.

In one embodiment, the methylamino-containing tertiary amine or primary etheramine having a pKa value greater than about 9 is a compound selected from:

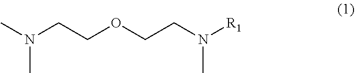

where R₁ is CH₃ or C₂H₄OH;

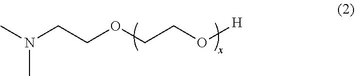

where x is an integer from 0 to 3;

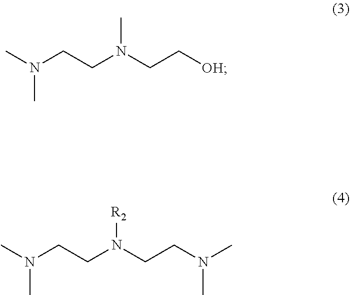

where R₂ is H, CH₃, C₂H₄OH or CH₂CH(CH₃)OH;

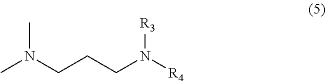

where each R₃ and R₄ are independently H, CH₃, C₃H₆N(CH₃)₂, C₂H₄OH or CH₂CH(CH₃)OH;

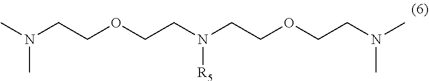

where R₅ is H, CH₃, C₂H₄OH or CH₂CH(CH₃)OH;

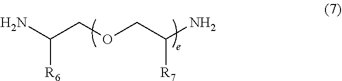

where R₆ and R₇ are independently hydrogen, methyl and ethyl and e is an integer from 1 to 10;

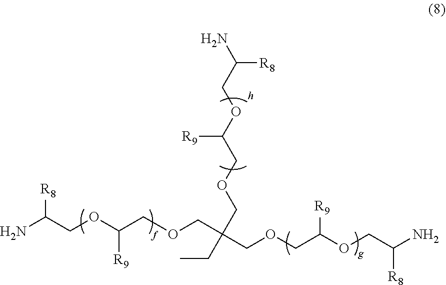

where each R₈ and R₉ are independently hydrogen, methyl, or ethyl and f, g and h are an integer from 1 to 8; N-methylpyrrolidine; dimethylcyclohexylamine and a mixture thereof.

Examples of the methylamino-containing tertiary amine having a pKa value greater than about 9 include, but are not limited to, tetramethylbis(aminoethyl)ether (JEFFCAT® ZF-20 amine), N,N,N′-trimethyl-N-hydroxyethylbisaminoethylether (JEFFCAT® ZF-10 amine), N-(3-dimethylaminopropyl)-N,N-diisopropanolamine (JEFFCAT® DPA amine), dimethylethanolamine (JEFFCAT® DMEA amine), dimethylcyclohexylamine (JEFFCAT® DMCHA), pentamethyldiethylenetriamine (JEFFCAT® PMTDA amine), pentamethyldipropylenetriamine (JEFFCAT® ZR-40 amine), tetramethyldipropylenetriamine (JEFFCAT® Z-130 amine), N,N-dimethyl-2(2-aminoethyoxy)ethanol (JEFFCAT® ZR-70 amine), N,N-bis(3-dimethylaminopropyl)-N-isopropanolamine (JEFFCAT® ZR-50 amine), trimethylaminoethyl-ethanolamine (JEFFCAT® Z 110 amine), 2-(2-(dimethylamino)ethoxy)-N-(2-(2-(dimethylamino)ethoxy)ethyl)-N-methylethan-1-amine (JEFFCAT® LE-30 amine), and 3-dimethylaminopropylamine.

In one particular embodiment, the primary etheramine having a pKa value greater than about 9 is a compound selected from:

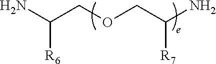

where each R₆ and R₇ independently are hydrogen, methyl, or ethyl and e, is an integer from 1 to 10; and

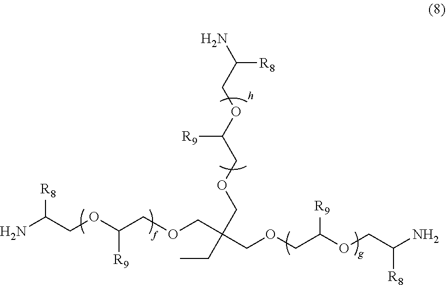

where each R₈ and R₉ are independently hydrogen, methyl, or ethyl and f, g and h are an integer from 1 to 8.

Examples of the primary etheramine having a pKa greater than about 9 include, but are not limited to, JEFFAMINE® D-230 amine, JEFFAMINE® D-400 amine, JEFFAMINE® T-403 amine, or JEFFAMINE® EDR-148 amine.

According to one embodiment, the compound having the formula (OH)ₐ—R—(COOH)_{b} is a compound having from 1 to 12 carbon atoms and may be a carboxylic acid, a dicarboxylic acid, a tricarboxylic acid, a phenolic acid, a substituted phenolic acid or a hydroxy substituted derivative thereof. Examples of R alkyl groups include, but are not limited to, methyl, ethyl, n-propyl, iso-propyl, propyl, butyl, iso-butyl, phenyl, ethylenyl, n-amyl, n-decyl or 2 ethylhexyl. While the aforementioned alkyl groups may comprise two available substitution sites, it is contemplated that additional hydrogens on the hydrocarbon could be replaced with further carboxyl and/or hydroxyl groups.

Particular compounds that may be used as the compound having the formula (OH)ₐ—R—(COOH)_{b} include, but are not limited to, a hydroxyl-carboxylic acid, adipic acid, glutaric acid, succinic acid, formic acid, acetic acid, malonic acid, maleic acid, glycolic acid, lactic acid, 2-hydroxybutyric acid, citric acid, AGS acid, phenol, cresol, hydroquinone, or combinations thereof. AGS acid is a mixture of dicarboxylic acids (i.e., adipic acid, glutaric acid, and succinic acid) that is obtained as a by-product of the oxidation of cyclohexanol and/or cyclohexanone in the adipic acid manufacturing process. Suitable AGS acid that may be used as component A include RHODIACID® acid (available from Solvay S.A.), DIBASIC acid (available from Invista S.a.r.l), FLEXATRAC™-AGS-200 acid (available from Ascend Performance Materials LLC), and glutaric acid, technical grade (AGS) (available from Lanxess A.G.).

In one embodiment, the protonated amine may be prepared in situ in the polyurethane formulation by adding the methylamino-containing tertiary amine or primary etheramine having a pKa value greater than 9 and the compound having the formula (OH)ₐ—R—(COOH)_{b} separately to the polyurethane formulation (or polyol resin blend), while in other embodiments, the protonated amine may be prepared prior to addition to the polyurethane formulation (or polyol resin blend) by contacting the methylamino-containing tertiary amine or primary etheramine having a pKa value greater than 9 with the compound having the formula (OH)ₐ—R—(COOH)_{b} in a suitable mixing vessel or in-line mixer.

According to some embodiments, the amine blend may include at least 5% by weight of the protonated amine, based on the total weight of the amine catalyst blend. In still other embodiments, the amine catalyst blend may include at least 10% by weight or at least 20% by weight or at least 30% by weight or at least 40% by weight, or at least 45% by weight of the protonated amine, based on the total weight of the amine catalyst blend.

According to other embodiments, the amine catalyst blend may include less than about 50% by weight of the protonated amine, based on the total weight of the amine catalyst blend. In still other embodiments, the amine catalyst blend may include less than 40% by weight or at least 30% by weight or at least 20% by weight or at least 15% by weight or at least 10% by weight of the protonated amine, based on the total weight of the amine catalyst blend.

In still other embodiments, the amine catalyst blend may include between about 5% by weight to about 50% by weight of the protonated amine, based on the total weight of the amine catalyst blend. In still other embodiments, the amine catalyst blend may include between about 10% by weight to about 40% by weight or between about 15% by weight to about 35% by weight or between about 20% by weight to about 30% by weight of the protonated amine, based on the total weight of the amine catalyst blend.

According to another embodiment, the amine catalyst blend above may be combined with a non-amine catalyst in forming the polyurethane foam or material. The non-amine catalyst is a compound (or mixture thereof) having catalytic activity for the reaction of an isocyanate group with a polyol or water, but is not a compound falling within the description of the (i) one or more amines having a pKa value of between about 6 and about 8.5 and or (ii) the protonated amine described above. Thus, in one embodiment, the amines (i) and (ii) in the amine catalyst blend above are the sole amines present in the polyurethane formulation (i.e. the polyol resin blend is substantially free of any other amine catalyst besides those in the amine catalyst blend). Examples of such additional non-amine catalysts include, for example:

tertiary phosphines, such as trialkylphosphines and dialkylbenzylphosphines;

chelates of various metals, such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co and Ni;

metal carboxylates such as potassium acetate and sodium acetate;

acidic metal salts of strong acids, such as ferric chloride, stannic chloride, stannous chloride, antimony trichloride, bismuth nitrate and bismuth chloride;

strong bases, such as alkali and alkaline earth metal hydroxides, alkoxides and phenoxides;

alcoholates and phenolates of various metals, such as Ti(OR⁶)₄, Sn(OR⁶)₄ and Al(OR⁶)₃ where R⁶ is alkyl or aryl, and the reaction products of the alcoholates with carboxylic acids, and beta-diketones;

alkaline earth metal, Bi, Pb, Sn or Al carboxylate salts; and tetravalent tin compounds, and tri- or pentavalent bismuth, antimony or arsenic compounds.

The amine catalyst blend may be used in a catalytically effective amount to catalyze the reaction between a compound containing an isocyanate functional group and an active hydrogen-containing compound for making rigid or flexible polyurethane foam or other polyurethane materials.

In particular, the amine catalyst blend may be used in a catalytically effective amount in the polyol resin blend to catalyze the reaction between a compound containing an isocyanate functional group and the polyol in the polyol resin blend for making rigid or flexible polyurethane foam or other polyurethane materials.

A catalytically effective amount of the amine catalyst blend may range from about 0.01-15 parts per 100 parts of polyol, and in some embodiments from about 0.05-12.5 parts per 100 parts of polyol, and in even further embodiments from about 0.1-7.5 parts per 100 parts of polyol, and yet in even further embodiments from about 0.5-5 parts per 100 parts of polyol.

The polyol resin blend also includes one or more halogenated olefin compounds that serve as a blowing agent. The halogenated olefin compound comprises at least one haloalkene (for e.g, fluoroalkene or chlorofluoroalkene) comprising from 3 to 4 carbon atoms and at least one carbon-carbon double bond. Suitable compounds may include hydrohaloolefins such as trifluoropropenes, tetrafluoropropenes (e.g., tetrafluoropropene (1234)), pentafluoropropenes (e.g., pentafluoropropene (1225)), chlorotrifloropropenes (e.g., chlorotrifloropropene (1233)), chlorodifluoropropenes, chlorotrifluoropropenes, chlorotetrafluoropropenes, hexafluorobutenes (e.g., hexafluorobutene (1336)), or combinations thereof. In certain embodiments, the tetrafluoropropene, pentafluoropropene, and/or chlorotrifloropropene compounds have no more than one fluorine or chlorine substituent connected to the terminal carbon atom of the unsaturated carbon chain (e.g., 1,3,3,3-tetrafluoropropene (1234ze); 1,1,3,3-tetrafluoropropene, 1,2,3,3,3-pentafluoropropene (1225ye), 1,1,1-trifluoropropene, 1,2,3,3,3-pentafluoropropene, 1,1,1,3,3-pentafluoropropene (1225zc), 1,1,2,3,3-pentafluoropropene (1225yc), (Z)-1,1,1,2,3-pentafluoropropene (1225yez), 1-chloro-3,3,3-trifluoropropene (1233zd), 1,1,1,4,4,4-hexafluorobut-2-ene (1336mzzm), or combinations thereof).

According to one embodiment, the halogenated olefin blowing agent may be a compound having the formula:

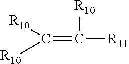

where each R₁₀ is independently Cl, F, H or CF₃, provided that the total number of carbon atoms is either 3 or 4;
R₁₁ is (C(R₁₀)₂)ₘY;

### Y is CF₃; and

m is 0 or 1. In one embodiment Y is CF₃ and at least two unsaturated carbons have a chlorine substituent.

Examples of such compounds include, 1,1,1,4, 4.4-hexafluoro-2-butene (1336), 1-chloro-3,3,3-trifluoropropene (1233zd), and 1,3,3,3-tetrafluoropropene (1234ze). In certain highly preferred aspects of such embodiments the 1-chloro-3,3,3-trifluoropropene (1233zd) is trans-1-chloro-3,3,3-trifluoropropene (1233zd(E)), the 1,3,3,3-tetrafluoropropene (1234ze) is trans-1,3,3,3-tetrafluoropropene (1234ze(E)), and the 1,1,14.4.4-hexafluoro-2-butene (1336) is cis-1,1,1,4,4,4-hexafluoro-2-butene (1336(Z)).

According to another embodiment, the halogenated olefin blowing may be a compound having the formula

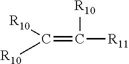

where each R₁₀ is independently Cl, F or H;
R₁₁ is (C(R₁₀)₂)ₙY;

### Y is CF₃; and

n is 0 or 1.

Examples of such compounds include 1-chloro-3,3,3-trifluoropropene (1233zd) (preferably trans-1233zd), 2,3,3,3-tetrafluoropropene (1234yf) and 1,3,3,3-tetrafluoropropene (1234ze) (preferably trans-1234ze). In certain of such embodiments, the 1-chloro-3,3,3-trifluoropropene (1233zd) is trans 1-chloro-3,3,3-trifluoropropene (1233zd(E)), the 1,3,3,3-tetrafluoropropene (1234ze) is trans 1,3,3,3-tetrafluoropropene (1234ze(E)), and the 1,1,14.4.4-hexafluoro-2-butene (1336) is cis 1,1,14.4.4-hexafluoro-2-butene (1336(Z)).

Other non-halogenated compounds may serve as blowing agents in the polyol formulation such as, but not limited to, air, nitrogen, carbon dioxide, hydrofluorocarbons (“HFCs”), alkanes, alkenes, mono-carboxylic acid salts, ketones, ethers, or combinations thereof. Suitable HFCs include 1,1-difluoroethane (HFC-152a), 1,1,1,2-tetrafluoroethane (HFC-134a), pentafluoroethane (HFC-125), 1,1,1,3,3-pentafluoropropane (HFC-245fa), 1,1,1,3,3-pentaflurobutane (HFC-365mfc) or combinations thereof. Suitable alkanes and alkenes include n-butane, n-pentane, isopentane, cyclopentane, 1-pentene, or combinations thereof. Suitable mono-carboxylic acid salts include methyl formate, ethyl formate, methyl acetate, or combinations thereof. Suitable ketones and ethers include acetone, dimethyl ether, or combinations thereof.

The amount of halogenated olefin compound blowing agent may vary widely depending on many factors including the type of foam being made using the blowing agent. According to some embodiments, the polyol resin blend may include from 0.5% by weight to 40% by weight or from 1% by weight to 40% by weight, or from 2% by weight to 40% by weight, or from 0.5% by weight to 30% by weight, or from 1% by weight to 30% by weight, or from 2% by weight to 30% by weight, or from 0.5% by weight to 25% by weight, or from 1% by weight to 25% by weight, or from 2% by weight to 25% by weight of the halogenated olefin compound blowing agent, based on the total weight of the polyol resin blend.

In particular embodiments where the polyol resin blend is for use in making flexible foam, the polyol resin blend may contain a relatively low amount of halogenated olefin compound blowing agent, for example from 0.5% by weight to 10% by weight, or from 0.5% by weight to 8% by weight, or from 0.5% by weight to 6% by weight, or from 0.5% by weight to 5% by weight, or from 0.5% by weight to 4% by weight, based on the total weight of the polyol resin blend. In other embodiments where the polyol resin blend is for use in making spray foam, the polyol resin blend may contain from 4% to 15% by weight halogenated olefin compound blowing agent, or from 6% by weight to 12% by weight halogenated olefin compound blowing agent, based on the total weight of the polyol resin blend. In still other embodiments where the polyol resin blend is for use in making appliance foam, PIR foam, and PUR foam the polyol resin blend may contain from about 5 wt % to about 30 wt % halogenated compound olefin blowing agent, or from about 10 wt % to about 30 wt % or from about 15 wt % to about 30 wt % halogenated olefin compound blowing agent, based on the total weight of the polyol resin blend.

In embodiments where the optional non-halogenated compound blowing agent is also present, the amount of the halogenated olefin compound blowing agent and non-halogenated olefin compound blowing agent in the blend of blowing agents can also vary widely, depending on several factors, including the type of foam being made. In such embodiments, the amount of the blend of blowing agents present in the polyol resin blend is the amount as described above (i.e. the amounts described above for the halogenated olefin compound blowing agent alone). In some embodiments, when the polyol resin blend is for use in making flexible foams, the amount of halogenated olefin compound blowing agent present in the blend of blowing agents may be from 40% by weight to 60% by weight and the amount of non-halogenated olefin compound blowing agent may be from 60% by weight to 40% by weight, based on the total weight of the blend of blowing agents. In embodiments where the polyol resin blend is for use in making spray foam, the amount of halogenated olefin compound blowing agent present in the blend of blowing agents may be from about 50% by weight to 85% by weight and the amount of non-halogenated olefin compound blowing agent may be from 50% by weight to 15% by weight, or the amount of halogenated olefin compound blowing agent may be from 60% by weight to 85% by weight and the amount of non-halogenated olefin compound blowing agent may be from 40% by weight to 15% by weight, based on the total weight of the blend of blowing agents. In embodiments where the polyol resin blend is for use in making appliance foams, PIR panel foams, and PUR panel foams the amount of halogenated olefin compound blowing agent in the blend of blowing agents may be from 90% by weight to 99% by weight and the amount of non-halogenated olefin compound blowing agent may be from about 10% by weight to 1% by weight, based on the total weight of the blend of blowing agents.

In still another embodiment, the polyol resin blend above may be used in a polyurethane formulation comprising a compound containing an isocyanate functional group and optional auxiliary components.

According to one embodiment, the compound containing an isocyanate functional group is a polyisocyanate and/or an isocyanate-terminated prepolymer.

Polyisocyanates include those represented by the general formula Q(NCO)_{d} where d is a number from 2-5, such as 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms.

Examples of polyisocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and 1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI); norbornane diisocyanates; m- and p-isocyanatophenyl sulfonylisocyanates; perchlorinated aryl polyisocyanates; modified polyisocyanates containing carbodiimide groups, urethane groups, allophanate groups, isocyanurate groups, urea groups, or biuret groups; polyisocyanates obtained by telomerization reactions; polyisocyanates containing ester groups; and polyisocyanates containing polymeric fatty acid groups. Those skilled in the art will recognize that it is also possible to use mixtures of the polyisocyanates described above.

Isocyanate-terminated prepolymers may also be employed in the preparation of the polyurethane. Isocyanate-terminated prepolymers may be prepared by reacting an excess of polyisocyanate or mixture thereof with a minor amount of an active-hydrogen containing compound as determined by the well-known Zerewitinoff test.

Polyols suitable for use in the polyol resin blend include, but are not limited to, polyalkylene ether polyols, polyester polyols, polymer polyols, a non-flammable polyol such as a phosphorus-containing polyol or a halogen-containing polyol. Such polyols may be used alone or in suitable combination as a mixture.

Polyalkylene ether polyols include poly(alkylene oxide) polymers such as poly(ethylene oxide) and polypropylene oxide) polymers and copolymers with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, digylcerol, trimethylol propane, and similar low molecular weight polyols.

Polyester polyols include, but are not limited to, those produced by reacting a dicarboxylic acid with an excess of a diol, for example, adipic acid with ethylene glycol or butanediol, or reaction of a lactone with an excess of a diol such as caprolactone with propylene glycol.

In addition to polyalkylene ether polyols and polyester polyols, polymer polyols are also suitable for use in the present disclosure. Polymer polyols are used in polyurethane materials to increase resistance to deformation, for example, to improve the load-bearing properties of the foam or material. Examples of polymer polyols include, but are not limited to, graft polyols or polyurea modified polyols (Polyharnstoff Dispersion polyols). Graft polyols comprise a triol in which vinyl monomers are graft copolymerized. Suitable vinyl monomers include, for example, styrene, or acrylonitrile. A polyurea modified polyol is a polyol containing a polyurea dispersion formed by the reaction of a diamine and a diisocyanate in the presence of a polyol. A variant of polyurea modified polyols are polyisocyanate poly addition (PIPA) polyols, which are formed by the in situ reaction of an isocyanate and an alkanolamine in a polyol.

The non-flammable polyol may, for example, be a phosphorus-containing polyol obtainable by adding an alkylene oxide to a phosphoric acid compound. A halogen-containing polyol may, for example, be those obtainable by ring-opening polymerization of epichlorohydrin or trichlorobutylene oxide.

In addition, the polyurethane formulation may optionally include one or more auxiliary components. Examples of auxiliary components include, but are not limited to, cell stabilizers, surfactants, chain extenders, pigments, fillers, flame retardants, thermally expandable microspheres, water, thickening agents, smoke suppressants, reinforcements, antioxidants, UV stabilizers, antistatic agents, infrared radiation absorbers, dyes, mold release agents, antifungal agents, biocides or any combination thereof.

Cell stabilizers may include, for example, silicon surfactants or anionic surfactants. Examples of suitable silicon surfactants include, but are not limited to, polyalkylsiloxane, polyoxyalkylene polyol-modified dimethylpolysiloxane, alkylene glycol-modified dimethylpolysiloxane, or any combination thereof.

Suitable surfactants (or surface-active agents) include emulsifiers and foam stabilizers, such as silicone surfactants known in the art, for example, polysiloxanes, as well as various amine salts of fatty acids, such as diethylamine oleate or diethanolamine stearate, as well as sodium salts of ricinoleic acids.

Examples of chain extenders include, but are not limited to, compounds having hydroxyl or amino functional groups, such as glycols, amines, diols, and water. Further non-limiting examples of chain extenders include ethylene glycol, propylene glycol, 1,4-butanediol, 1,3-butanediol, 1,5-pentanediol, 1,6-hexanediol, 1,10-decanediol, 1,12-dodecanediol, ethoxylated hydroquinone, 1,4-cyclohexanediol, N-methylethanolamine, N-methylisopropanolamine, 4-aminocyclo-hexanol, 1,2-diaminoethane, or any mixture thereof.

Pigments may be used to color code the polyurethane materials during manufacture, to identify product grade, or to conceal yellowing. Pigments may include any suitable organic or inorganic pigments. For example, organic pigments or colorants include, but are not limited to, azo/diazo dyes, phthalocyanines, dioxazines, or carbon black. Examples of inorganic pigments include, but are not limited to, titanium dioxide, iron oxides or chromium oxide.

Fillers may be used to increase the density and load bearing properties of polyurethane foam or material. Suitable fillers include, but are not limited to, barium sulfate, carbon black or calcium carbonate.

Flame retardants can be used to reduce flammability. For example, such flame retardants include, but are not limited to, chlorinated phosphate esters, chlorinated paraffins or melamine powders.

Thermally expandable microspheres include those containing a (cyclo)aliphatic hydrocarbon. Such microspheres are generally dry, unexpanded or partially unexpanded microspheres consisting of small spherical particles with an average diameter of typically 10 to 15 micron. The sphere is formed of a gas proof polymeric shell (e.g. consisting of acrylonitrile or PVDC), encapsulating a minute drop of a (cyclo)aliphatic hydrocarbon, e.g. liquid isobutane. When these microspheres are subjected to heat at an elevated temperature level (e.g. 150° C. to 200° C.) sufficient to soften the thermoplastic shell and to volatilize the (cyclo)aliphatic hydrocarbon encapsulated therein, the resultant gas expands the shell and increases the volume of the microspheres. When expanded, the microspheres have a diameter 3.5 to 4 times their original diameter as a consequence of which their expanded volume is about 50 to 60 times greater than their initial volume in the unexpanded state. Examples of such microspheres are the EXPANCEL®-DU microspheres which are marketed by AKZO Nobel Industries of Sweden.

The methods for producing a polyurethane material from a polyurethane formulation according to the present disclosure are well known to those skilled in the art and can be found in, for example, U.S. Pat. Nos. 5,420,170, 5,648,447, 6,107,359, 6,552,100, 6,737,471 and 6,790,872, the contents of which are hereby incorporated by reference. Various types of polyurethane materials can be made, such as rigid foams, flexible foams, semi-flexible foams, microcellular elastomers, backings for textiles, spray elastomers, cast elastomers, polyurethane-isocyanurate foams, reaction injection molded polymers, structural reaction injection molded polymers and the like.

A non-limiting example of a general flexible polyurethane foam formulation having a 15-150 kg/m³ density (e.g. automotive seating) containing the amine catalyst blend and halogenated olefin blowing agent may comprise the following components in parts by weight (pbw):

| Flexible Foam Formulation | pbw |
|---|---|
| Polyol | 20-100 |
| Surfactant | 0.3-3 |
| Halogenated olefin | 1-6 |
| Crosslinker | 0-3 |
| Amine catalyst blend | 0.2-2.5 |
| Isocyanate Index | 70-115 |

A non-limiting example of a general rigid polyurethane foam formulation having a 15-70 kg/m³ density containing the amine catalyst blend and halogenated olefin blowing agent may comprise the following components in parts by weight (pbw):

| Rigid Foam Formulation | Pbw |
|---|---|
| Polyol | 100 |
| Surfactant | 1-3 |
| Halogenated olefin | 8-15 |
| Water | 0-3 |
| Amine catalyst blend | 0.5-3 |
| Isocyanate Index | 80-400 |

The amount of the compound containing an isocyanate functional group is not limited, but will generally be within those ranges known to one skilled in the art. An exemplary range given above is indicated by reference to Isocyanate Index which is defined as the number of equivalents of isocyanate divided by the total number of equivalents of active hydrogen, multiplied by 100.

Thus, in yet another embodiment, the present disclosure provides a method for producing a polyurethane material which comprises contacting the compound containing an isocyanate functional group, the polyol resin blend according to the present disclosure, and optional auxiliary components.

In one particular embodiment, the polyurethane material is a rigid or flexible foam prepared by bringing together the polyol resin blend comprising at least one active hydrogen-containing compound, such as a polyol, the amine catalyst blend, the halogenated olefin blowing agent and a compound containing an isocyanate functional group to form a reaction mixture and subjecting the reaction mixture to conditions sufficient to cause the active hydrogen-containing compound to react with the compound containing an isocyanate functional group. The polyol resin blend and compound containing an isocyanate functional group may be heated prior to mixing them and forming the reaction mixture. In other embodiments, the polyol resin blend and compound containing an isocyanate functional group are mixed at ambient temperature (for e.g. from about 15°-40° C.) and heat may be applied to the reaction mixture, but in some embodiments, applying heat may not be necessary. The polyurethane foam may be made in a free rise (slabstock) process in which the foam is free to rise under minimal or no vertical constraints. Alternatively, molded foam may be made by introducing the reaction mixture in a closed mold and allowing it to foam within the mold. The particular active hydrogen-containing compound and compound containing an isocyanate functional group are selected with the desired characteristics of the resulting foam. Other auxiliary components useful in making polyurethane foams, such as those described above, may also be included to produce a particular type of foam.

According to another embodiment, a polyurethane material may be produced in a one-step process in which an A-side reactant (isocyanate component comprising a compound containing an isocyanate functional group) is reacted with a B-side reactant (polyol resin blend). The isocyanate component may comprise a polyisocyanate while the polyol resin blend may comprise an active-hydrogen containing compound, such as a polyol, the amine catalyst blend and halogenated olefin. In some embodiments, the isocyanate component and/or polyol resin blend may also optionally contain other auxiliary components such as those described above.

The polyurethane materials produced may be used in a variety of applications, such as, a precoat; a backing material for carpet; building composites; insulation; spray foam insulation; applications requiring use of impingement mix spray guns; urethane/urea hybrid elastomers; vehicle interior and exterior parts such as bed liners, dashboards, door panels, and steering wheels; flexible foams (such as furniture foams and vehicle component foams); integral skin foams; rigid spray foams; rigid pour-in-place foams; coatings; adhesives; sealants; filament winding; and other polyurethane composite, foams, elastomers, resins, and reaction injection molding (RIM) applications.

The present disclosure also provides a method of stabilizing a polyol resin blend comprising a polyol (or “B side”) for an extended period of time by adding the amine catalyst blend of the present disclosure to the polyol resin blend.

The present disclosure will now be further described with reference to the following non-limiting examples.

### EXAMPLES

Description of the Foam Reactivity Test.
(i) An A-side (isocyanate component) and B-side (polyol resin blend) are equilibrated to room temperature (˜20° C.);
(ii) 50 g of equilibrated A-side and B-side are poured into a 32-oz non-waxed paper cup;
(iii) The combined components are mixed for 4 seconds at 2500 rpm using a mechanical mixer and allowed to react and form the polyurethane foam product; and
(iv) One or more of the composition's cream time, top of cup, string time, tack free time, and/or end of rise (each described below) properties are measured during the formation of the polyurethane foam product.
   Cream Time—cream time is the elapsed time between the moment an isocyanate component is mixed with the polyol component and the formation of a fine froth or cream in the mixture.
   Top of Cup—top of cup represents the time required for the polyurethane foam product to fill a 32 oz. cup.
   String Time—string time is measured by putting the thin edge of a wooden, medical tongue depressor into expanding foam once every second and observing when a trail of string is pulled by the tongue depressor from the expanding foam. The string time is defined as the length of time after mixing of the isocyanate component with the polyol component to the point when a string is first pulled.
   Tack Free Time—tack free time is the time required from initial mixing for the foam to achieve a condition such that an exposed surface thereof is tack free when contacted lightly by the flat side of wooden, medical tongue depressor.
   End of Rise—end of rise time is the elapsed time between the moment the isocyanate component is mixed with the polyol component and the point at which the foam rise is complete.
   All times in the following tables are listed in seconds.

### Example 1. Conventional Amine Catalysts/Halogenated Olefin Blowing Agent

Five parts by weight of a state of the art amine catalyst blend containing equal parts by weight of JEFFCAT® ZF-10, ZF-50 and Z-110 amines was combined with 1.8 parts by weight water and 93.2 parts by weight of a standard polyol masterbatch that included other standard B-side ingredients such as flame retardants and the halogenated olefin blowing agent (Table A). This proportion of ingredients was used for all subsequent examples as well, with only the specific amine or amine blend changing.

TABLE A

| Component | Percent |
|---|---|
| TEROL ® 925 polyol | 48.76 |
| JEFFOL ® R-425-X polyol | 9.32 |
| JEFFOL ® SG-522 polyol | 7.34 |
| SAYTEX ® RB-79 | 6.34 |
| Tris(1-chloro-2-propyl)phosphate | 10.25 |
| silicone surfactant | 0.93 |
| 1233zd(E) | 10.25 |
| water | 1.8 |
| amine catalyst | 5.0 |
| Total | 100 |

This fully formulated B-side was stored at a temperature of 40° C. and samples were taken at various time intervals and subsequently reacted with the isocyanate component to produce polyurethane foam. Various performance properties were measured and the results were as follows:

TABLE 1

| | | 1 | 2 | 3 | 4 | 5 | 6 |
|---|---|---|---|---|---|---|---|
| Property | Initial | Week | Weeks | Weeks | Weeks | Weeks | Weeks |
| Cream Time | 4 | 5 | 6 | 7 | 8 | 10 | 11 |
| Top of Cup | 7 | 10 | 16 | 19 | 22 | 26 | 29 |
| String Time | 9 | 13 | 19 | 22 | 26 | 29 | 32 |
| Tack Free | 11 | 15 | 21 | 25 | 29 | 33 | 35 |
| End of Rise | 16 | 22 | 29 | 33 | 37 | 44 | 50 |

As shown above, the top of cup time increased by about 314% by the end of the study demonstrating the rapid degradation of the B-side due to the reaction of the amines with the halogenated olefin blowing agent.

### Example 2. Acid Blocked Amine Catalysts/Halogenated Blowing Agent

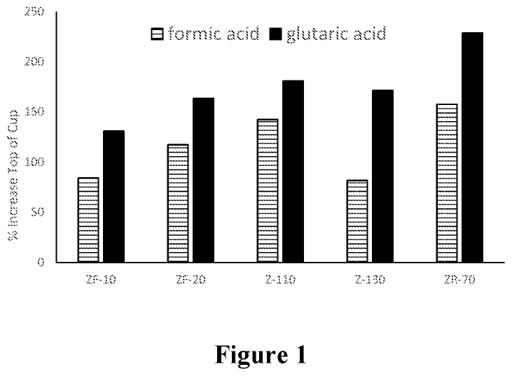

Fully acid blocked amines as identified in the title of Tables 2-11 were combined with a halogenated olefin blowing agent 1233zd(E), available as Solstice® LBA from Honeywell and used in the B-side (polyol resin blend) of the two-component foam formulation. The B-side was stored at 50° C. and samples were taken at various time intervals and subsequently reacted with the A-side (isocyanate component) to produce polyurethane foam. Various performance properties were measured as above and are shown in FIG. 1 and the tables below:

TABLE 2
JEFFCAT ® ZF-10 amine blocked with formic acid

| | | 1 | 2 | 3 | 4 | 5 | 6 |
|---|---|---|---|---|---|---|---|
| Property | Initial | Week | Weeks | Weeks | Weeks | Weeks | Weeks |
| Cream Time | 7 | 8 | 9 | 9 | 10 | 11 | 12 |
| Top of Cup | 20 | 21 | 22 | 24 | 30 | 32 | 34 |
| String Time | 29 | 34 | 36 | 36 | 39 | 43 | 47 |
| Tack Free | 38 | 42 | 47 | 48 | 55 | 57 | 64 |
| Time | | | | | | | |
| End of Rise | 48 | 51 | 57 | 59 | 67 | 72 | 79 |

TABLE 3
JEFFCAT ® ZF-110 amine blocked with formic acid

| | | 1 | 2 | 3 | 4 | 5 | 6 |
|---|---|---|---|---|---|---|---|
| Property | Initial | Week | Weeks | Weeks | Weeks | Weeks | Weeks |
| Cream | 7 | 7 | 8 | 8 | 9 | 10 | 11 |
| Time | | | | | | | |
| Top of Cup | 17 | 17 | 18 | 19 | 23 | 25 | 26 |
| String Time | 26 | 27 | 29 | 29 | 36 | 38 | 39 |
| Tack Free | 33 | 33 | 35 | 38 | 44 | 47 | 50 |
| Time | | | | | | | |
| End of Rise | 44 | 43 | 46 | 48 | 55 | 59 | 62 |

TABLE 4
JEFFCAT ® ZF-10 amine blocked with glutaric acid

| | | 1 | 2 | 3 | 4 | 5 | 6 |
|---|---|---|---|---|---|---|---|
| Property | Initial | Week | Weeks | Weeks | Weeks | Weeks | Weeks |
| Cream | 5 | 6 | 7 | 8 | 9 | 10 | 11 |
| Time | | | | | | | |
| Top of Cup | 12 | 15 | 19 | 23 | 29 | 33 | 40 |
| String Time | 22 | 26 | 32 | 38 | 47 | 49 | 57 |
| Tack Free | 29 | 34 | 41 | 48 | 57 | 67 | 82 |
| End of Rise | 36 | 42 | 53 | 62 | 70 | 81 | 95 |

TABLE 5
JEFFCAT ® ZF-110 amine blocked with glutaric acid

| | | 1 | 2 | 3 | 4 | 5 | 6 |
|---|---|---|---|---|---|---|---|
| Property | Initial | Week | Weeks | Weeks | Weeks | Weeks | Weeks |
| Cream Time | 5 | 6 | 7 | 8 | 9 | 10 | 11 |
| Top of Cup | 14 | 17 | 22 | 25 | 32 | 35 | 41 |
| String Time | 21 | 27 | 33 | 38 | 44 | 49 | 55 |
| Tack Free | 26 | 30 | 39 | 50 | 60 | 65 | 80 |
| Time | | | | | | | |
| End of Rise | 37 | 40 | 51 | 63 | 71 | 81 | 95 |

TABLE 6
JEFFCAT ® ZR-70 amine blocked with formic acid

| | | 1 | 2 | 3 | 4 | 5 | 6 |
|---|---|---|---|---|---|---|---|
| | Initial | Week | Weeks | Weeks | Weeks | Weeks | Weeks |
| Cream | 6 | 6 | 6 | 7 | 8 | 9 | 9 |
| Top of Cup | 14 | 15 | 17 | 22 | 28 | 34 | 41 |
| String | 21 | 21 | 23 | 29 | 36 | 41 | 48 |
| Tack Free | 26 | 27 | 28 | 36 | 44 | 55 | 67 |
| End of Rise | 34 | 34 | 35 | 45 | 53 | 66 | 76 |

TABLE 7
JEFFCAT ® ZR-70 amine blocked with glutaric acid

| | | 1 | 2 | 3 | 4 | 5 | 6 |
|---|---|---|---|---|---|---|---|
| | Initial | Week | Weeks | Weeks | Weeks | Weeks | Weeks |
| Cream | 4 | 4 | 4 | 4 | 5 | 6 | 7 |
| Top of Cup | 7 | 10 | 13 | 17 | 19 | 25 | 30 |
| String | 12 | 14 | 19 | 22 | 25 | 30 | 39 |
| Tack Free | 14 | 17 | 23 | 28 | 31 | 38 | 46 |
| End of Rise | 19 | 22 | 29 | 38 | 42 | 50 | 61 |

TABLE 8
JEFFCAT ® LE-30 amine blocked with formic acid

| | | 1 | 2 | 3 | 4 | 5 | 6 |
|---|---|---|---|---|---|---|---|
| | Initial | Week | Weeks | Weeks | Weeks | Weeks | Weeks |
| Cream | 7 | 7 | 8 | 8 | 8 | 9 | 11 |
| Top of Cup | 18 | 19 | 21 | 23 | 25 | 28 | 33 |
| String | 26 | 29 | 31 | 33 | 36 | 39 | 46 |
| Tack Free | 34 | 35 | 38 | 43 | 44 | 48 | 59 |
| End of Rise | 43 | 44 | 48 | 55 | 58 | 61 | 72 |

TABLE 9
JEFFCAT ® LE-30 amine blocked with glutaric acid

| | | 1 | 2 | 3 | 4 | 5 | 6 |
|---|---|---|---|---|---|---|---|
| | Initial | Week | Weeks | Weeks | Weeks | Weeks | Weeks |
| Cream | 5 | 5 | 6 | 7 | 7 | 8 | 8.5 |
| Top of Cup | 10 | 13 | 18 | 21 | 26 | 32 | 41 |
| String | 17 | 22 | 27 | 35 | 40 | 47 | 53 |
| Tack Free | 20 | 26 | 35 | 44 | 49 | 59 | 74 |
| End of Rise | 28 | 34 | 44 | 60 | 66 | 76 | 88 |

TABLE 10
JEFFCAT ® ZF-10 amine blocked with acetic acid

| | | 1 | 2 | 3 | 4 | 5 | 6 |
|---|---|---|---|---|---|---|---|
| | Initial | Week | Weeks | Weeks | Weeks | Weeks | Weeks |
| Cream | 7 | 9 | 11 | 13 | 14 | 16 | 19 |
| Top of Cup | 20 | 22 | 25 | 30 | 34 | 41 | 47 |
| String | 27 | 32 | 35 | 41 | 46 | 50 | 56 |
| Tack Free | 37 | 40 | 47 | 52 | 58 | 66 | 75 |
| End of Rise | 50 | 52 | 58 | 71 | 75 | 86 | 97 |

TABLE 11
JEFFAMINE ® D-230 amine blocked with formic acid

| | Initial |
|---|---|
| Cream | 12 |
| Top of Cup | 51 |
| String | 109 |
| Tack Free | 210 |
| End of Rise | DNF |

As demonstrated in FIG. 1, acids can be used in connection with amine catalysts and halogenated olefin blowing agents to improve stability and reduce degradation of the polyol component. The tables above also show that, in general, stronger acids yield more stable amines and weaker acids allow for faster front-end cream times but yield more unstable systems. This instability during storage and the increases observed in the rise profile times during storage associated with the use of acids still demonstrates the polyol component has unacceptable stability and would not be of commercial value.

### Example 3. Electronically Deactivated Amine Catalyst/Halogenated Olefin Blowing Agent

An electronically deactivated catalyst, (JEFFCAT® H-1 amine), a blend of 1,2-dimethylimidazole and JEFFCAT® DMDEE in ethylene glycol solvent, was used in the B-side (polyol component) of a two-component foam formulation as in Table 1. The B-side was stored at 50° C. and samples were taken at various times and reacted with the A-side (isocyanate component) to produce polyurethane foam. Various performance properties were measured as above and the results are shown below:

TABLE 12

| | | 1 | 2 | 3 | 4 | 5 | 6 |
|---|---|---|---|---|---|---|---|
| Property | Initial | Week | Weeks | Weeks | Weeks | Weeks | Weeks |
| Cream Time | 7 | 7 | 7 | 7 | 7 | 7 | 8 |
| Top of Cup | 13 | 13 | 13 | 13 | 13 | 13 | 13 |
| String Time | 15 | 16 | 16 | 16 | 15 | 16 | 16 |
| Tack Free | 18 | 19 | 28 | 18 | 17 | 18 | 18 |
| Time | | | | | | | |
| End of Rise | 25 | 25 | 25 | 24 | 24 | 24 | 24 |

As one skilled in the art is aware, the cream time can be used as a good indication of whether a system will have ample front-end reactivity to be useful in spray foam applications. Generally, in the experience of the inventors, a cream time less than or equal to 5 seconds, measured in a cup foam at room temperature, indicates the front-end reactivity is fast enough for a commercial system whereas a cream time that is greater than 6 seconds indicates the front-end reactivity may be too slow for commercial spray foam formulations. The results in Table 12 demonstrate that when the polyol component includes an electronically deactivated amine blend and halogenated olefin blowing agent, the polyol component is highly stable as shown by the lack of change in the performance properties above. However, the front-end reactivity with this blend is not acceptable as shown by the cream times which are greater than 5 seconds. The reason for a slow cream time is the lack of a fast blowing catalyst—the 1,2-dimethylimidazole provides the gelling but the JEFFCAT® DMDEE catalyst is too weak of a blowing catalyst to properly “kick off” the reaction.

It should be noted here that the use of metal catalysts and/or heated hoses in the applicator system can be used to “heat up” the front end as well so there may be occasions where, for instance, a 5-second cream time in a cup foam may yield acceptable results in an industrial spray application system.

### Example 4. Inventive Amine Catalysts Blend/Halogenated Olefin Blowing Agent

The problem of slow front-end reactivity with the previous example was solved with the inventive examples, where an acid-blocked strong blowing catalyst with a pKa value above 9 is combined with electronically deactivated amines with pKa values below 8.5.

The following inventive amine catalyst blends were formed:

Amine catalyst blend 1 included 40% by weight of JEFFCAT® DMDEE catalyst (dimorpholinodiethylether), 40% by weight 1,2-dimethlyimidazole and 20% by weight of JEFFCAT® ZF-10 catalyst blocked with formic acid;

Amine catalyst blend 2 included 40% by weight of JEFFCAT® DMDEE (dimorpholinodiethylether), 40% by weight 1,2-dimethlyimidazole and 20% by weight of JEFFCAT® LE-30A protonated by glutaric acid.

Amine catalyst blend 3 included 35% JEFFCAT® DMDEE catalyst, 35% 1,2-dimethylimidazole, and 30% by weight of JEFFCAT® LE-30A catalyst blocked with formic acid

Amine catalyst blend 4 included 40% JEFFCAT® DMDEE catalyst, 40% 1,2-dimethylimidazole, and 20% JEFFCAT® Z-110 catalyst blocked with formic acid

Amine catalyst blend 5 contained 40% JEFFCAT® DMDEE catalyst, 40% 1,2-dimethylimidazole, and 20% JEFFAMINE® D-230 blocked with formic acid

Amine catalyst blend 6 contained 41% JEFFCAT® DMDEE catalyst, 41% 1,2-dimethylimidazole, and 18% JEFFCAT® ZF-10 catalyst blocked with formic acid

Amine catalyst blend 7 contained 41% JEFFCAT® DMDEE catalyst, 41% 1,2-dimethylimidazole, and 18% JEFFCAT® ZF-10 catalyst blocked with glutaric acid

The amine catalyst blends 1 to 7 were separately added to the polyol resin blend of Table 1.

Each of the polyol resin blends were stored at 50° C. and samples were taken at various times and subsequently reacted with the A-side (isocyanate component) to produce a polyurethane foam. Various performance properties were measured as above and the results are shown in the tables below:

TABLE 13
Foam Produced Using Amine Catalyst Blend 1

| | | 1 | 2 | 3 | 4 | 5 | 6 |
|---|---|---|---|---|---|---|---|
| | Initial | Week | Weeks | Weeks | Weeks | Weeks | Weeks |
| Cream | 5 | 5 | 5 | 5 | 6 | 6 | 6 |
| Top of Cup | 10 | 10 | 10 | 10 | 11 | 11 | 12 |
| String | 13 | 13 | 14 | 14 | 15 | 14 | 15 |
| Tack Free | 15 | 16 | 17 | 16 | 17 | 17 | 17 |
| End of Rise | 23 | 24 | 24 | 23 | 24 | 24 | 25 |

TABLE 14
Foam Produced Using Polyol Resin Blend
Containing Amine Catalyst Blend 2

| Property | Initial | 1 Week | 2 Weeks | 3 Weeks |
|---|---|---|---|---|
| Cream Time | 5 | 5 | 5 | 5 |
| Top of Cup | 11 | 11 | 12 | 13 |
| String Time | 14 | 15 | 15 | 16 |
| Tack Free Time | 17 | 17 | 18 | 18 |
| End of Rise | 24 | 25 | 25 | 25 |

TABLE 15
Foam rise profiles using Polyol Resin Blend
Containing Amine Catalyst Blend 3:

| | | 1 | 2 | 3 | 4 | 5 | 6 |
|---|---|---|---|---|---|---|---|
| | Initial | Week | Weeks | Weeks | Weeks | Weeks | Weeks |
| Cream | 5 | 5 | 6 | 6 | 6 | 7 | 7 |
| Top of Cup | 10 | 10 | 11 | 12 | 12 | 13 | 14 |
| String | 14 | 15 | 15 | 16 | 16 | 18 | 18 |
| Tack Free | 17 | 18 | 18 | 19 | 19 | 21 | 22 |
| End of Rise | 25 | 25 | 25 | 26 | 27 | 29 | 30 |

TABLE 16
Foam rise profiles using Polyol Resin Blend
Containing Amine Catalyst Blend 4:

| | | 1 | 2 | 3 | 4 | 5 | 6 |
|---|---|---|---|---|---|---|---|
| | Initial | Week | Weeks | Weeks | Weeks | Weeks | Weeks |
| Cream | 5 | 5 | 5 | 6 | 6 | 7 | 7 |
| Top of Cup | 11 | 11 | 12 | 12 | 12 | 13 | 13 |
| String | 14 | 14 | 14 | 15 | 16 | 17 | 16 |
| Tack Free | 16 | 17 | 18 | 18 | 19 | 20 | 20 |
| End of Rise | 25 | 26 | 26 | 27 | 28 | 29 | 28 |

TABLE 17
Foam rise profiles using Polyol Resin
Blend Containing Amine Catalyst Blend 5

| | Initial | 1 Week | 2 Weeks |
|---|---|---|---|
| Cream | 6 | 6 | 6 |
| Top of Cup | 12 | 12 | 12 |
| String | 16 | 16 | 17 |
| Tack Free | 19 | 20 | 19 |
| End of Rise | 27 | 28 | 27 |

TABLE 18
Foam rise profiles using Polyol Resin Blend
Containing Amine Catalyst Blend 6

| | | 1 | 2 | 3 | 4 | 5 | 6 |
|---|---|---|---|---|---|---|---|
| | Initial | Week | Weeks | Weeks | Weeks | Weeks | Weeks |
| Cream | 5 | 5 | 5 | 5 | 6 | 6 | 6 |
| Top of Cup | 10 | 10 | 10 | 10 | 11 | 11 | 12 |
| String | 14 | 14 | 13 | 14 | 15 | 15 | 15 |
| Tack Free | 16 | 17 | 17 | 16 | 17 | 18 | 18 |
| End of Rise | 23 | 23 | 23 | 24 | 25 | 26 | 27 |

TABLE 19
Foam rise profiles using Polyol Resin Blend
Containing Amine Catalyst Blend 7

| | | 1 | 2 | 3 | 4 | 5 | 6 |
|---|---|---|---|---|---|---|---|
| | Initial | Week | Weeks | Weeks | Weeks | Weeks | Weeks |
| Cream | 5 | 5 | 5 | 6 | 6 | 6 | 7 |
| Top of Cup | 10 | 11 | 10 | 11 | 12 | 13 | 13 |
| String | 13 | 14 | 13 | 14 | 15 | 15 | 16 |
| Tack Free | 16 | 17 | 17 | 18 | 18 | 19 | 20 |
| End of Rise | 23 | 23 | 24 | 25 | 26 | 27 | 27 |

As shown above, the inventive polyol resin blends containing novel amine catalyst blends in combination with a halogenated olefin blowing agent surprisingly provided both high reactivity and acceptable stability over time, and are therefore a significant improvement over state of the art catalyst/halogenated olefin blowing agent systems.

What is claimed is:

1. A polyol resin blend comprising: (a) an amine catalyst blend comprising (i) one or more amines having a pKa value between about 6 and about 8.5 and (ii) a protonated amine obtained by contacting a methylamino-containing tertiary amine or primary etheramine having a pKa value greater than about 9 with a compound having a formula (OH)ₐ—R—(COOH)_{b} where R is selected from hydrogen, an alkyl, alkenyl, cycloaliphatic, aromatic, and alkylaromatic group, a and b are integers between 0 and 3 with the proviso that a+b≥1, and when a=1 and b=0, R is selected from an aromatic group and an alkylaromatic group; (b) a polyol; and (c) a halogenated olefin compound blowing agent.

2. The polyol resin blend according to claim 1 wherein the (i) one or more amines having a pKa between about 6 and about 8.5 is selected from an alkyl piperazine, an alkoxylated piperazine, a morpholine compound, an imidazole and a mixture thereof.

3. The polyol resin blend according to claim 2 wherein the (i) one or more amines having a pKa value between about 6 and about 8.5 is selected from imidazole, 1-methylimidazole, 1,2-dimethylimidazole, 2,4-dimethylimidazole, 1-methyl-2-hydroxyethylimidazole, 4,5-dimethylimidazole, 1,2,4,5-tetramethylimidazole, 1-hydroxyethylimidazole, 1-hydroxyethyl-2-methylimidazole, 1,2-dimethylpiperazine, morpholine, N-methylmorpholine, N-ethylmorpholine, N-butylmorpholine, dimorpholinodiethylether and a mixture thereof.

4. The polyol resin blend according to claim 1 wherein the methylamino-containing tertiary amine or primary etheramine having a pKa value greater than about 9 is selected from 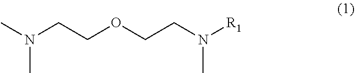
where R₁ is CH₃ or C₂H₄OH; 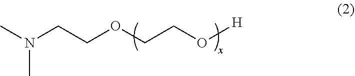
where x is an integer from 0 to 3; 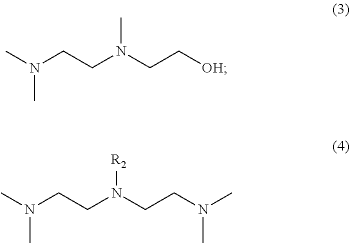
where R₂ is H, CH₃, C₂H₄OH or CH₂CH(CH₃)OH; 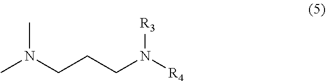
where each R₃ and R₄ are independently H, CH₃, C₃H₆N(CH₃)₂, C₂H₄OH or CH₂CH(CH₃)OH; 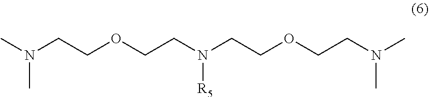
where R₅ is H, CH₃, C₂H₄OH or CH₂CH(CH₃)OH; 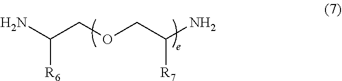
where R₆ and R₇ are independently hydrogen, methyl and ethyl and e is an integer from 1 to 10; 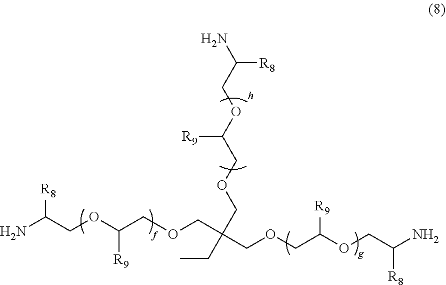
where each R₈ and R₉ are independently hydrogen, methyl, or ethyl and f, g and h are an integer from 1 to 8; N-methylpyrrolidine; dimethylcyclohexylamine and a mixture thereof.

5. The polyol resin blend according to claim 4 wherein the methylamino-containing tertiary amine or primary etheramine having a pKa value greater than about 9 is selected from tetramethylbis(aminoethyl)ether, N,N,N′-trimethyl-N-hydroxyethylbisaminoethylether, N-(3-dimethylaminopropyl)-N,N-diisopropanolamine, dimethylethanolamine, dimethylcyclohexylamine, pentamethyldiethylenetriamine, pentamethyldipropylenetriamine, tetramethyldipropylenetriamine, N,N-dimethyl-2(2-aminoethyoxy)ethanol, N,N-bis(3-dimethylaminopropyl)-N-isopropanolamine, trimethylaminoethyl-ethanolamine, 3-dimethylaminopropyl amine, polyoxypropylene diamine, trimethylolpropane poly(oxypropylene)triamine, and a mixture thereof.

6. The polyol resin blend according to claim 4 wherein the compound having the formula (OH)ₐ—R—(COOH)_{b} is a hydroxyl-carboxylic acid, adipic acid, glutaric acid, succinic acid, formic acid, acetic acid, malonic acid, maleic acid, glycolic acid, lactic acid, 2-hydroxybutyric acid, citric acid, phenol, cresol, hydroquinone or a combination thereof.

7. The polyol resin blend according to claim 1 wherein the amine catalyst blend comprises between 10% by weight to 90% by weight of the (i) one or more amines having a pKa value between about 6 and about 8.5, based on the total weight of the amine catalyst blend.

8. The polyol resin blend according to claim 1 wherein the amine catalyst blend comprises between 5% by weight to 50% by weight of the (ii) protonated amine, based on the total weight of the amine catalyst blend.

9. The polyol resin blend according to claim 1 wherein the halogenated olefin compound comprises a trifluoropropene, a tetrafluoropropene, a pentafluoropropene, a chlorotrifloropropene, a chlorodifluoropropene, a chlorotrifluoropropene, a chlorotetrafluoropropene, a hexafluorobutene or a mixture thereof.

10. A polyurethane formulation comprising the polyol resin blend according to claim 1 and a compound containing an isocyanate functional group.

11. The polyurethane formulation according to claim 10 further comprising a non-halogenated olefin compound blowing agent and/or a non-amine catalyst.

12. A method for producing a polyurethane material comprising contacting a compound containing an isocyanate functional group and, optionally, auxiliary components with a polyol resin blend comprising: (a) an amine catalyst blend comprising (i) one or more amines having a pKa value between about 6 and about 8.5 and (ii) a protonated amine obtained by contacting a methylamino-containing tertiary amine or a primary etheramine having a pKa value greater than about 9 and a compound having a formula (OH)ₐ—R—(COOH)_{b} where R is selected from hydrogen, an alkyl, alkenyl, cycloaliphatic, aromatic, or alkylaromatic group, a and b are integers between 0 and 3 with the proviso that a+b≥1, and when a=1 and b=0, R is aromatic or alkylaromatic; (b) a polyol; and (c) a halogenated olefin compound blowing agent.

13. A polyurethane material produced according to the method of claim 12.

14. The polyurethane material according to claim 13 wherein the polyurethane material is a rigid foam or a flexible foam.

15. The polyurethane material according to claim 12 wherein the polyurethane material is a precoat, a backing material for carpet, a building composite, insulation, a spray foam insulation, a urethane/urea hybrid elastomers; in vehicle interior and exterior parts, a flexible foam, an integral skin foam, a rigid spray foam, a rigid pour-in-place foam; a coating; an adhesive, a sealant, or a filament winding.

16. A method of producing a polyol resin blend that is stable for an extended period of time comprising contacting the polyol resin blend comprising a polyol with (a) an amine catalyst blend comprising (i) one or more amines having a pKa value between about 6 and about 8.5 and (ii) a protonated amine obtained by contacting a methylamino-containing tertiary amine or a primary etheramine having a pKa value greater than about 9 and a compound having a formula (OH)ₐ—R—(COOH)_{b} where R is selected from hydrogen, an alkyl, alkenyl, cycloaliphatic, aromatic, or alkylaromatic group, a and b are integers between 0 and 3 with the proviso that a+b≥1, and when a=1 and b=0, R is selected from an aromatic group and an alkylaromatic group; and (b) a halogenated olefin compound blowing agent.
